(19) United States
(12) Patent Application Publication
(10) Pub. No.: US 2003/0015097 A1
(43) Pub. Date: Jan. 23, 2003

(54) Facility for improving environmental atmosphere of interior space

(76) Inventor: W. P. Lu, Taipei (TW)

Correspondence Address: DOUGHERTY & TROXELL, Suite 1404, 5205 Leesburg Pike, Falls Church, VA, 22041, US

(21) Appl. No.: 09/906,728

(22) Filed: Jul. 18, 2001

(51) Int. Cl. B03C 3/01

(52) U.S. Cl. 96/55

(57) ABSTRACT

A facility for improving environmental atmosphere of interior space, which comprises: a negative ion discharger; a plurality of electric poles connect to the output wires of the negative ion discharger; the aforementioned negative ion discharger is placed in a corner of interior space, and the plurality of electric poles are situated in the upper part of the interior space. By means of the active carbon layer beneath the floor indoors, an invisible shelter will be form by the negative ions released from the negative ion discharger; accordingly, the energy of ion will be effectively decreased, and the particle condition of indoor space will be harmonized. In addition, proper proportion of active carbon and zeolite are mixed with concrete, wherein a predetermined amount of active carbon is buried in the cavities by the building, in order to absorb the moisture and the calcium, magnesium, and sodium, to purify the interior atmosphere, to diminish the humidity of the air indoors, and to lift the health of the people living in such space.

### BACKGROUND OF THE INVENTION

1.Field of the invention

The present invention relates to a facility for improving environmental atmosphere of interior space, and especially to a facility for improving environmental atmosphere of interior space which improves the atmosphere of the interior environment, and diminish the humidity of the indoor spaces.

2. Description of the Prior Art

As everybody knows, the resource of human body movements is energy. For example, our living spaces that relate to the energy of electricity and atmosphere, also closely relate to human body. Also as we know, one of the essential natural elements in our living spaces is structured by ions with electric charges, for example, NaCl, the main component of salt, is composed of the ion of Na⁺ and the negative ion of Cl⁻ with negative electric charges. Generally, the more the ions in the atmosphere, the more negative ions are consumed. So if we could supply sufficient negative ions to the indoor atmosphere, it would be of a great help to improve the indoor atmosphere and interior environment.

On the contrary, if there are less negative ions in the indoor atmosphere, there might be defects such as:

1. The walls of the kitchen and the bathroom might be moldy, especially in rainy seasons.

2. Accordingly, there would be more cockroaches and termites in the room, and the smell of the indoor spaces would stink.

3. In addition, people who live in such space would have more chances to get ill, e.g., if they catch a cold, it is not easy for them to be cured.

In addition, as we know, modern buildings are made of concrete and steel. Generally, the wall made of concrete and steel may absorb moisture from the air, because usually the concrete/cement consists of limestone and clay, mixed with soft wallastonite, shales, pyrite, being ground into powders. The chemical composition of cement is silicic acid 21.60%, aluminite (6.23%, ferric oxide 2.53%, limestone 64.81%, bitter clay 1.63%, sulfate 1.75%, undissolvable dregs 0.67%. However, the wall made of concrete and steel does not completely resist the invasion of moisture.

In order to improve the aforementioned defects from the shortcoming of insufficient interior negative ions, the inventor of the present invention has made a great effort and disclosed many novel designs, eventually this invention of the facility for improving environmental atmosphere of interior space is invented.

### SUMMARY OF THE INVENTION

Accordingly, the object of the present invention is to provide a proper proportion of the ions and negative ions of indoor atmospheric environment, that is, to provide a proper concentration of interior negative ions and well-situated indoor atmospheric energy. Another object of the present invention is that since the number of interior negative ions is increased, the energy of the interior atmosphere becomes more stable, so that the walls and the windows of the kitchen and the bathroom may not be moldy, and there won't be cockroaches and termites in the room.

Another object of the present invention is that since the air quality of the interior environment is improved, people live in such a space won't get ill easily, the immunity of people against diseases may be strengthened, in time, the people live in a such space will be healthier.

Another object of the present invention is that since the interior atmospheric environment is improved and there are less cockroaches and termites in the room, the air quality indoors is purified, and the damage of furniture and other equipment caused by those insects would lessen.

A further object of the present invention is that since the moisture indoors decreases, people who live in such space would have less respiratory problems and their body would be in a better state.

A more complete understanding of these and other features and ill become advantages of the present invention will become apparent from a careful consideration of the following detailed description of certain embodiments illustrated in the accompanying drawing.

### BRIEF DESCRIPTION OF THE DRAWINGS

FIG. 1 shows the main structure of the facility of the present invention.

FIG. 2 is the first embodiment of the present invention in practical uses.

FIG. 3 is the second embodiment of the present invention in practical uses.

### DETAILED DESCRIPTION OF THE PREFERRED EMBODIMENT

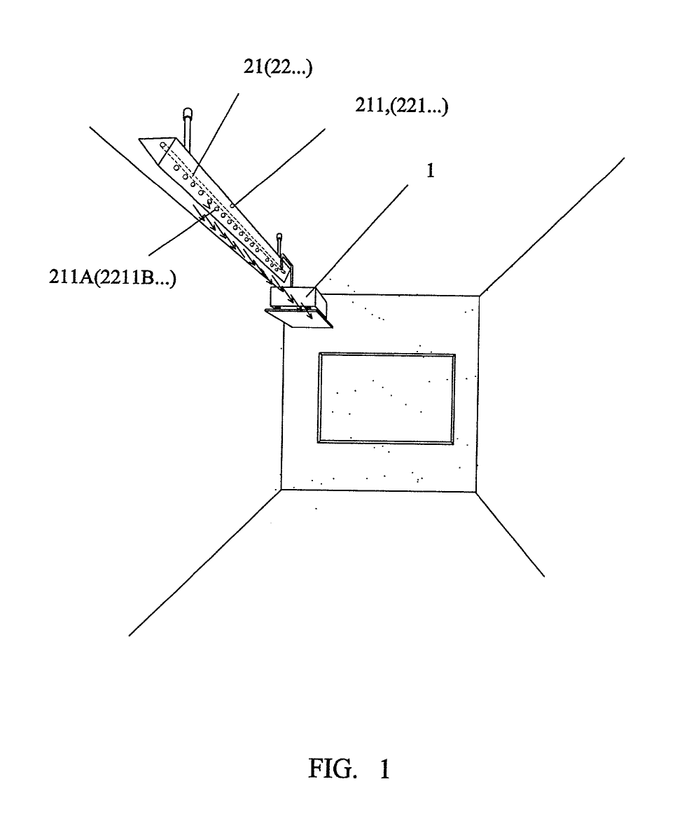

Referring now to FIG. 1, the facility for improving environmental atmosphere of interior space of the present invention is composed of an negative ion discharger 1, a plurality of electric poles 21, 22 . . . , which is connected to the output wires of the negative ion discharger 1. As is shown in FIG. 1, there is a rod 210, 220 . . . ., on each of the electric poles 21, 22 . . . ; each rod is covered by a housing 211,221 . . . ; each housing 211,221 . . . , is formed with a plurality of small apertures 211A, 211B . . . , in order to disperse the negative ions from the negative ion discharger 1 into the interior space.

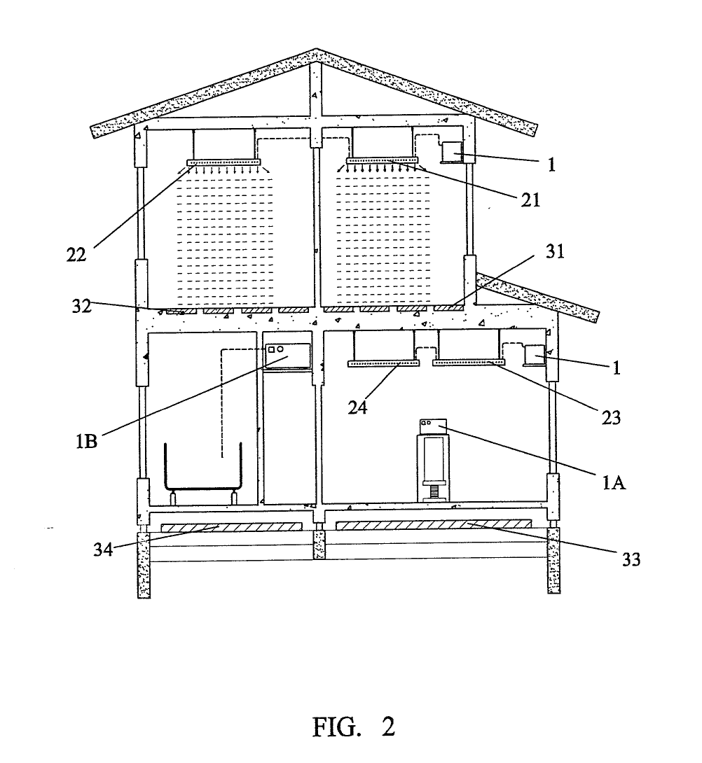

Accordingly, as shown in FIG. 2, it is preferably to place the electric poles 21, 22 . . . , in the upper part of the interior space.

The floor inside the interior space is equipped with layers of active carbon 31,32,33,34. For this reason, when the negative ions are released by the electric poles 21, 22 . . . , there will be an invisible shelter of negative ions in order to block pernicious particles from outside according to the performance of the aforementioned layers of active carbon 31,32,33,34.

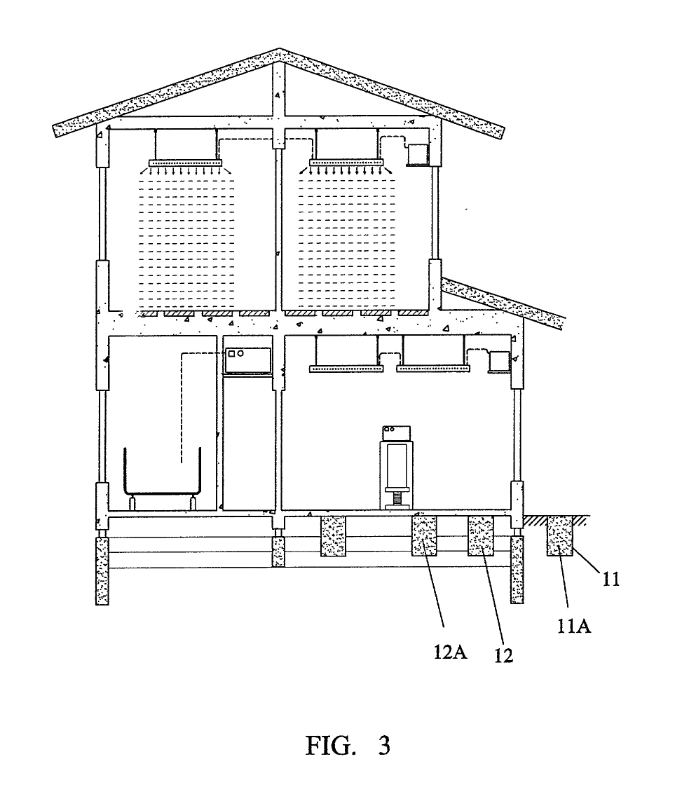

In addition, as shown in FIG. 3, there is also a plurality of cavities 11,12 . . . , having one meter of diameter and one meter of depth under the floor. There are also active carbon 11A,12A . . . , placed in these cavities. In this way, the moisture indoors may be absorbed by the aforementioned active carbon. Meanwhile, the soil may be dry, and the energy may increase.

Active carbon and zeolite may also be mixed with cement. The proportion of the active carbon is 12-13 kg/m² of cement, and the proportion of the zeolite is 20 kg/m² of cement.

Zeolite(Na₂O.Al₂O₃.2SiO₂.XH₂O) is made of kaolin(2.5-3.0), melted sodium borate(0-2.4), quartz(0-1.2), aluminum oxide(0-2.0), sodium carbonate(6.5-20.0); and it may be a natural water softener. When the hard water is percolated by zeolite, the calcium and the magnesium in the hard water may be substitute by the sodium in sodium silicone sulfate, so that there will not be calcium and the magnesium in the water, and the water becomes soft water.

When the cement is mixed with zeolite and active carbon, the wall, the slab, and the ceiling of the building contain these two elements, and these two elements may absorb the moisture content and calcium and magnesium in the air, so that the air quality of space that people live in will be greatly improved, and the people who live in such space will be in a better health. Also, there will not be enough moisture to harm the furniture and other interior facilities or equipments indoors.

In addition, as shown in FIG. 2, the aforementioned negative ion discharger 1 may also be situated to release negative ions into drinking water. Moreover, it may also be situated to release negative ions into the bathing water when people are taking bath.

Accordingly, from the aforementioned description, the facility for interior atmospheric environment improvement of present invention certainly has the effect of improving the atmosphere of the interior environment and diminishing the humidity of the indoor environment without using the artificial energy. It is than an invention worthy for many kinds of applications

Although the present invention has been described with a certain degree of particularity, the present disclosure has been made by way of example and changes in detail of structure may e made without departing the spirit thereof.

What is claimed is:

1. A facility for improving environmental atmosphere of interior space, characterized in that:
active carbon and zeolite are mixed with cement; when building a house;
an indoor atmospheric environment improving apparatus is installed in the interior space of a building, it includes: an negative ion discharger and a plurality of electric poles connect to the output wires of the negative ion discharger; the negative ion discharger is placed in a corner of interior space, the electric poles are placed in the upper part of the interior space; in this way, the energy of ion and electron may decrease, the particle condition of indoor space will be harmonized, and the interior atmospheric environment will be improved.

2. The facility for improving environmental atmosphere of interior space as claimed in claim 1, wherein the electric pole connect to the output wires of negative ion discharger is similar to a rod, which is covered with non-conductive housing with a plurality of apertures.

3. The facility for improving environmental atmosphere of interior space as claimed in claim 1, wherein the electric poles are situated in upper part of interior space.

4. The facility for improving environmental atmosphere of interior space as claimed in claim 1, wherein the negative ion discharger is connected to the container of drinking water.

5. The facility for improving environmental atmosphere of interior space as claimed in claim 1, wherein the negative ion discharger is connected to the container of bathing water.

6. The facility for improving environmental atmosphere of interior space as claimed in claim 1, wherein beneath the floor indoors are situated with layers of active carbon in order to form an invisible shelter of negative ions.

7. The facility for improving environmental atmosphere of interior space as claimed in claim 1, wherein the proportion of the active carbon is 12-13 kg/m² of cement.

8. The facility for improving environmental atmosphere of interior space as claimed in claim 1, wherein the proportion of the zeolite is 20 kg/m² of cement.

9. The facility for improving environmental atmosphere of interior space as claimed in claim 1, wherein active carbon is buried in the cavities by the building.
